(19) United States
(12) Patent Application Publication
(10) Pub. No.: US 2019/0316377 A1
(43) Pub. Date: Oct. 17, 2019

(54) Solar Parasol with Motion Sensor Switch

(71) Applicants: Linhai Taiji Crafts Co., Ltd., Linhai City (CN); ATLeisure LLC, Atlanta, GA (US)

(72) Inventor: Li Chuan, Linhai City (CN)

(73) Assignees: Linhai Taiji Crafts Co., Ltd., Linhai City (CN); ATLeisure LLC, Atlanta, GA (US)

(21) Appl. No.: 15/951,345

(22) Filed: Apr. 12, 2018

(51) Int. Cl. E04H 15/10; E04H 15/28; F21V 33/00; F21V 23/04; F21V 17/12

(52) U.S. Cl. CPC E04H 15/10; E04H 15/28; E04H 15/48; F21V 23/0485; F21V 17/12; F21V 33/006

(57) ABSTRACT

A solar parsasol having a motion sensor switch for controlling an LED light array. Holes are provided in the supporting ribs to house the light array on a single side only, providing greatly increased strength and wind resistance.

### TECHNICAL FIELD

The practical new model involves a kind of solar parasol, especially a solar parasol with a motion sensor switch for an LED light. The light can be turned on/off by touching LED light's touch switch control section at any spot, or the designated place on the parasol. It is suitable for beaches, courtyards, parks, house & hotel lawn, all field trip and open-air stalls and other outdoor uses.

### BACKGROUND

With the rapid development of tourism, the pole parasol, as an outdoor leisure utensil, is used broadly in squares, beaches, parks, courtyards and other leisure places, which provides people with comfortable leisure & cool-enjoying space.

Currently, on existing solar parasols' poles or ribs, control switches for light are installed. The switch is exposed on the surface and the LED light body on the ribs is in the form of string lights. Such structure leads to complex threading and difficult production. When existing solar parasols are used in strong winds, their ribs will become deformed and even broken easily, because in such parasols the rib and assembled LED string lights are connected by drilling holes. Parasols' main ribs, stretchers, poles and upper and lower hub are connected as a single entity, so when they are opened and used, the above 3 moving connection points are joined into a fixed triangle. Normally, umbrella cloth is directly fixed with the main rib. Winds blowing the umbrella canopy will cause all the wind force on ribs, the strength of which is greatly weakened when holes drilled on ribs are considered. When solar parasols with such structure meet strong winds, their ribs are certain to be damaged.

### SUMMARY

The present model will solve technical problems based on the above-mentioned technical status and provide a kind of solar parasol with a motion sensor switch whose ribs only need holes drilled on a single side with no switch exposed on the surface.

The model is a solar parasol with motion sensor switch produced by the following scheme. Like all parasols, it includes a canopy and frame; the described solar parasol has a pole, on top of which upper and lower hub are connected with the canopy and frame. On the pole of this parasol an operating mechanism is set for opening and closing the frame and canopy, and such mechanism is connected with another operating mechanism for winding rope. The solar parasol with motion sensor switch is novel as follows: the described poles and operating mechanisms for opening and closing the frame and canopy can be set as a motion sensor touch switch area. On top of the pole, the upper hub is fixed, and such upper hub is connected to the rib, which is then joined with supporting stretcher. One end of this stretcher is connected to the lower hub, which is installed on the pole and can slide up and down along the pole so that the canopy is opened.

The described rib connected to the upper hub can rotate around the upper hub on demand; the described supporting stretcher connected to the rib can rotate around the rib on demand; the described supporting stretcher can be rotated on demand around the lower hub connected to the supporting stretcher; the described lower hub's sliding up and down can open and close parasols; the motion sensor touch switch area on the described solar parasol's pole and closing operating mechanism can be set at the rib, hub and other desired places for convenient use.

Compared with current solar parasols, the present model has the following advantages: 1. compact appearance and being easy to use; 2. simple processing and easy assembly; 3. high strength of ribs and durable parasols. The solar parasol can be widely accepted by users and is worth popularizing; it is suitable for beaches, courtyards, parks, house & hotel lawn, all field trip, open-air stalls and other places.

### BRIEF DESCRIPTION OF THE DRAWINGS

FIG. 1 is the diagram of separate touch electronic circuit for the central light and rib light on the solar parasol with touch induction switch;

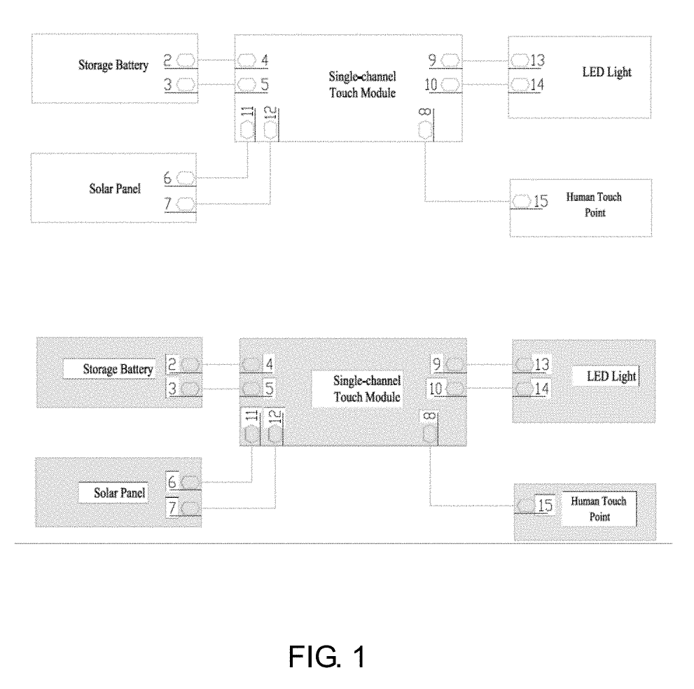

FIG. 2 is the diagram of integrated touch electronic circuit for the central light and rib light on the solar parasol with touch induction switch;

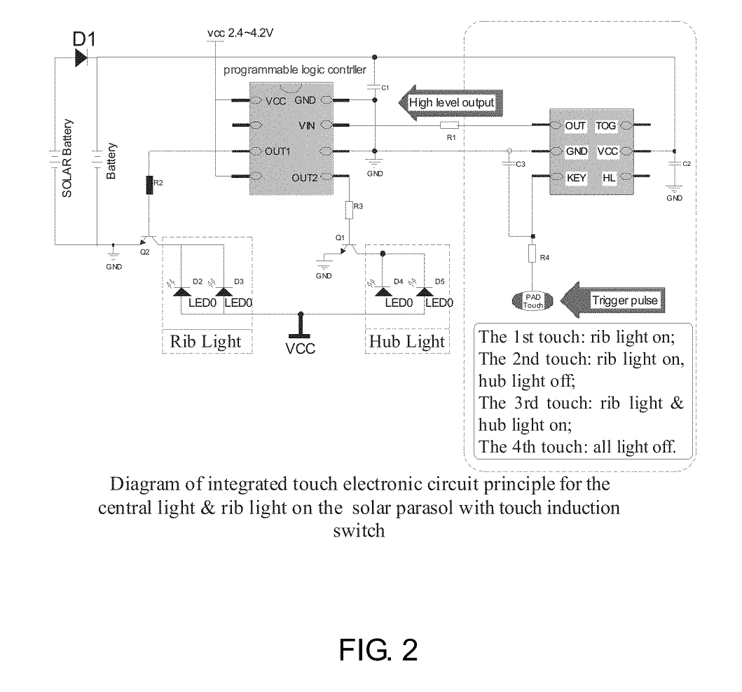

FIG. 3 is the diagram of settable touch belt No.1 for the solar parasol with touch induction switch;

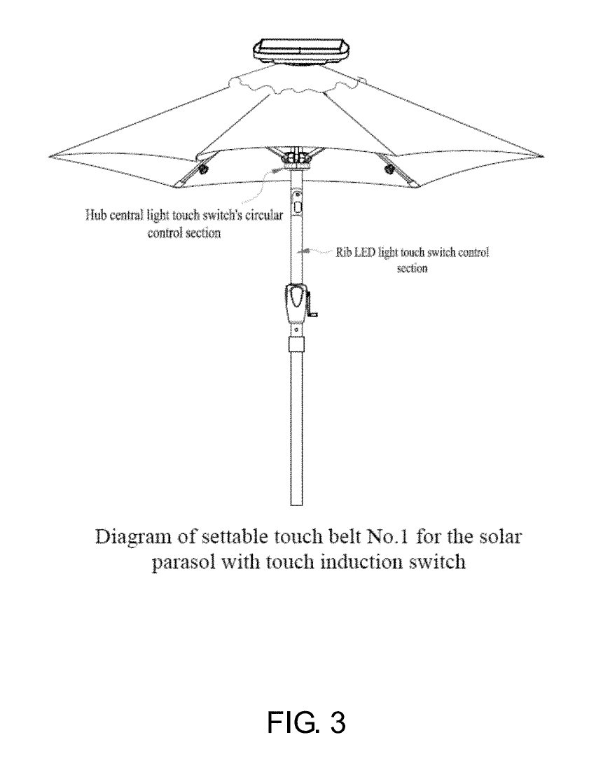

FIG. 4 is the diagram of settable touch belt No.2 for the solar parasol with touch induction switch;

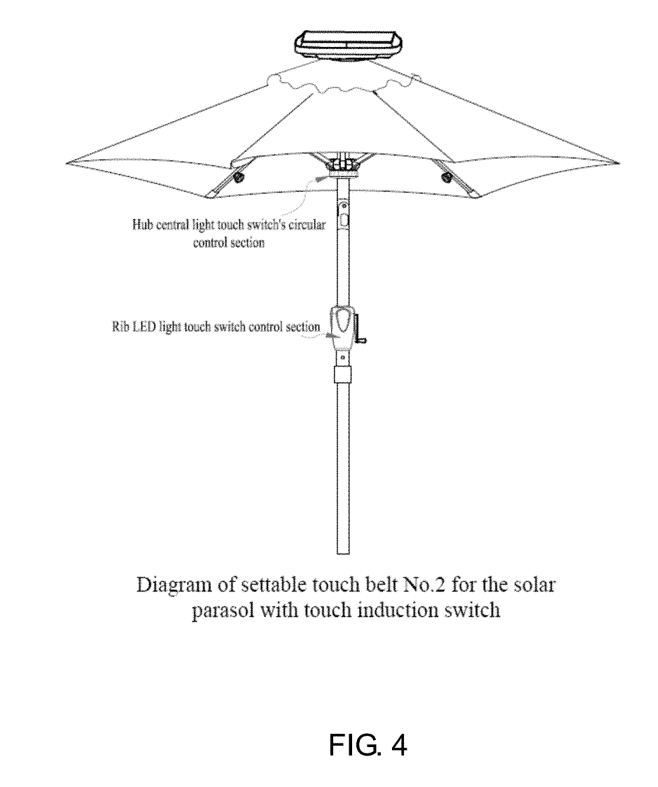

FIG. 5 is the diagram of settable touch belt No.3 for the solar parasol with touch induction switch;

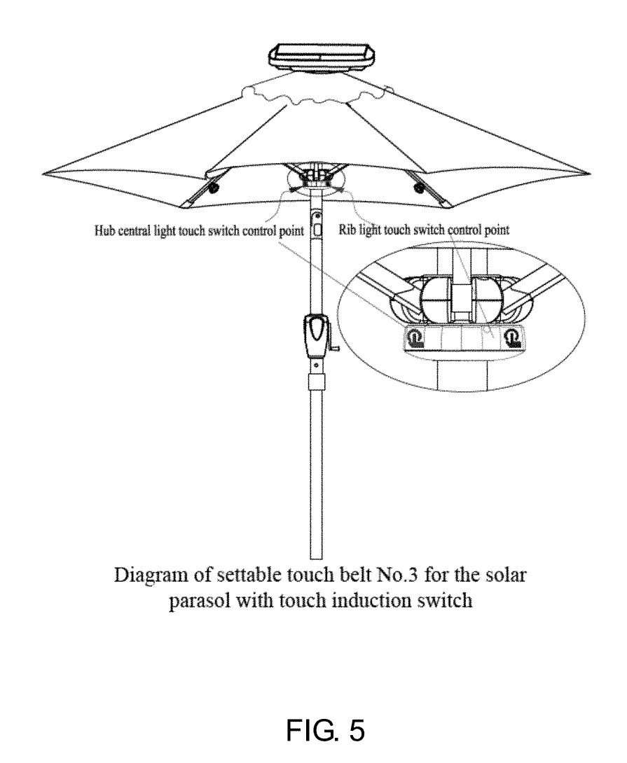

FIG. 6 is the diagram of frame structure for a pole-supported solar parasol with touch induction switch;

FIG. 7 is the diagram of frame structure for a hanging solar parasol with touch induction switch;

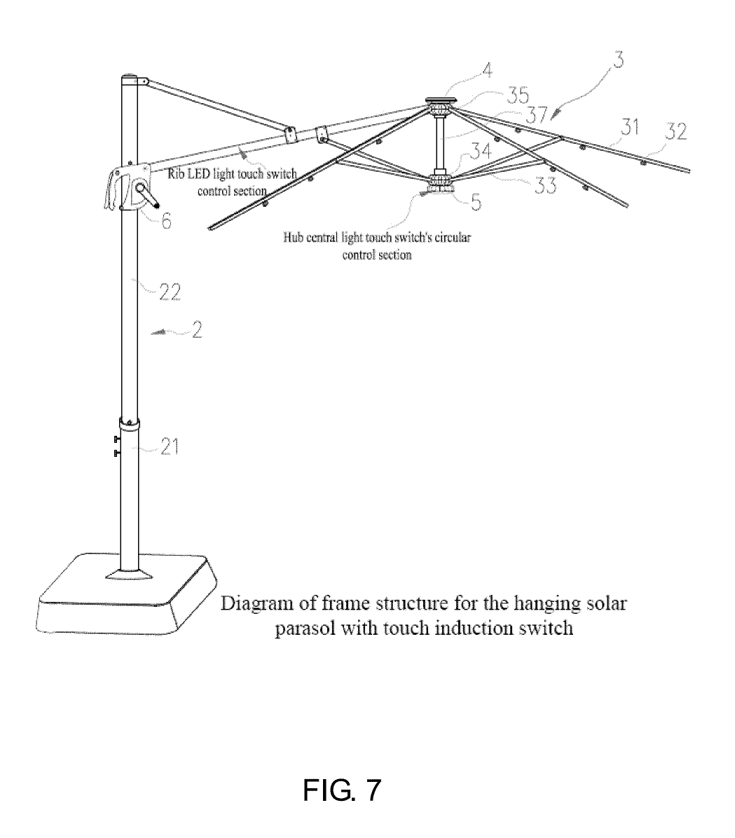

FIG. 8 is the structure diagram of connection between PC strip light and rib for the solar parasol;

FIG. 9 is the structure diagram of existing solar parasol with switch; and,

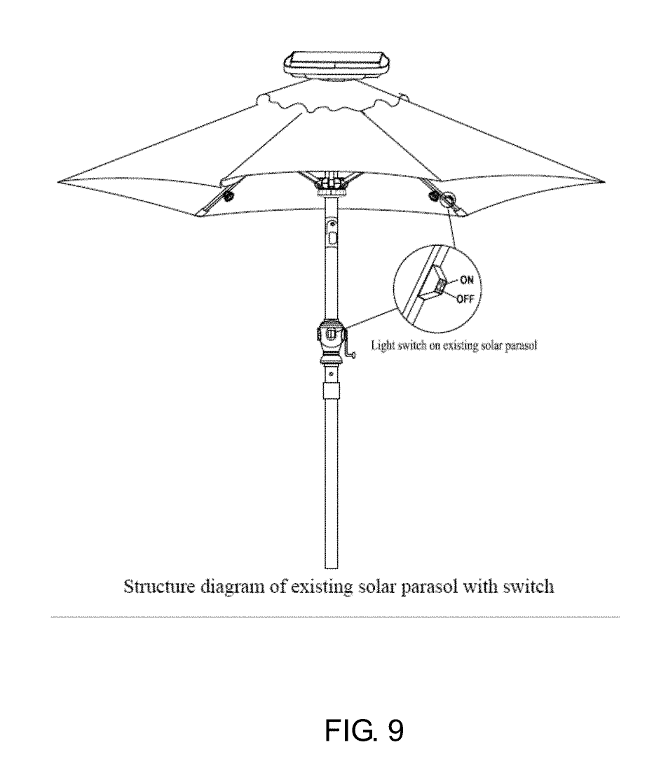

FIG. 10 is the structure diagram of existing solar parasols' ribs.

### DETAILED DESCRIPTION

The following is a detailed description of an embodiment example for the present device with attached diagrams.

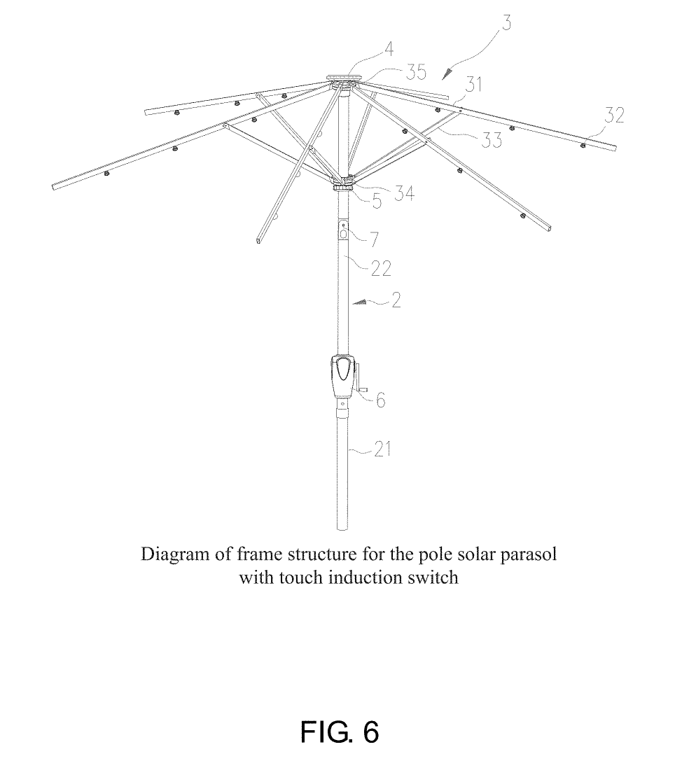

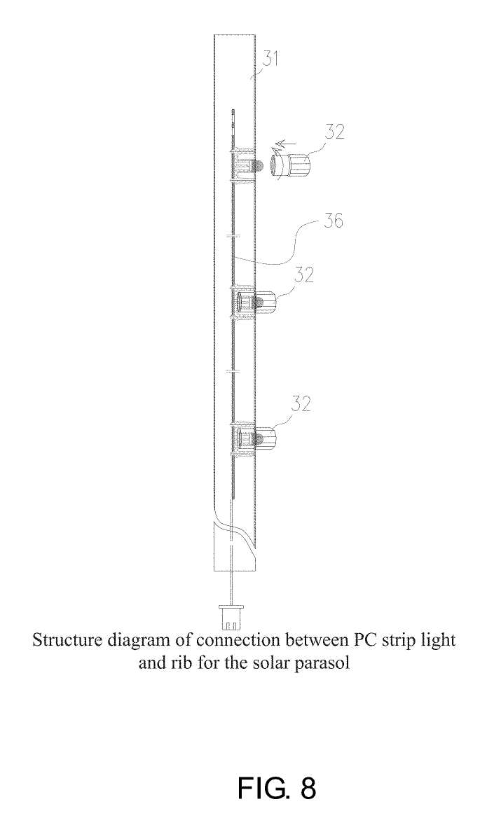

As is shown in FIG. 6, it is a kind of solar parasol with motion sensor switch. The pole parasol includes upper pole (22), lower pole (21), wire-winding mechanism for opening the parasol (6), tilt mechanism (7), sliding lower hub (34), supporting stretcher (33), rib (31), solar system (4), canopy (1), fixed upper hub (35), LED lamp cap (32)and PC strip light body (36), as is shown in FIGS. 6 and 8.

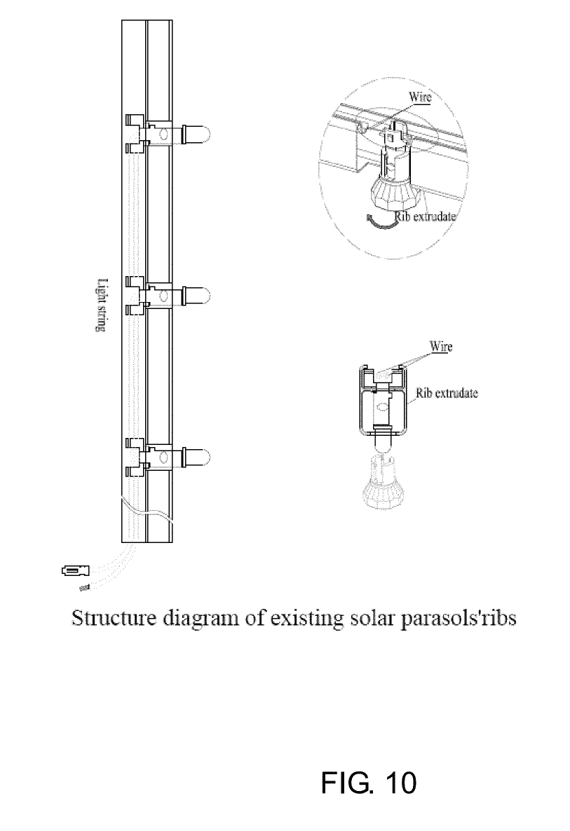

On the described upper pole (22) are fixed upper hub (35) and sliding lower hub (34). A tilt mechanism (7) is set in the middle of upper pole (22) and lower pole (21), and a solar system (4) is on fixed upper hub (35). One end of rib (31) supporting the canopy (1) is connected to fixed upper hub (35). One end of supporting stretcher (33), which supports rib (31), is joined to sliding lower hub (34), and the other end is hinge connected to the middle of rib (31). When rib (31), supporting stretcher (33), upper pole (22), lower pole (21) and tilt mechanism (7) are used to open canopy (1), 3 moving connection points are joined into a fixed triangle. Winds blowing the canopy will cause all the wind force on rib (31). If all the wind force is on canopy (1), it must turn outwards. The canopy (1) can make main rib (31) under stress directly, so the strength of ribs will be greatly increased if ribs only have holes drilled on a single side, as shown in FIG. 8. In existing solar parasols, holes are directly drilled on ribs with string-light structures as shown in FIG. 10. This greatly reduces solar parasols' service life, as opposed to the present device.

1. A solar parasol with motion sensor switch, comprising a canopy (1) and frame (3), an upper pole (22) and lower pole (21) on said frame (3); a tilt mechanism (7) set in the middle of upper pole (22) and lower pole (21); an upper hub (35) fixed on the top of said upper pole (22); said upper hub (35) connected to a rib (31); rib (31) being joined to a supporting stretcher (33); with one end of said supporting stretcher (33) connected to lower hub (34); lower hub (34) being installed on pole (21), pole (22), and tilt mechanism (7) such that said lower hub can slide up and down along pole (21) & pole (22) and tilt mechanism (7).

2. (canceled)

3. A solar parasol with motion sensor switch as defined in claim 1 in which a PC hard strip light (36) is set in a tube of said rib (31),and said strip and rib being connected to each other by single-wall drilling.

4. A solar parasol with motion sensor switch as defined in claim 1 in which: a PC hard strip light (36) is installed, in a tube of said rib (31) and connected to an external lamp cap (32) by thread knob.

5-6. (canceled)

7. An apparatus comprising:
a pole;
an upper hub fixed on the top of said pole;
an elongated rib with a proximal end connected to said upper hub;
an elongated stretcher with a first end connected to said elongated rib and a second end connected to a lower hub; and
a PC hard strip light;
said lower hub slideably connected to said pole;
said pole optionally comprising an upper pole, a lower pole, and a tilt mechanism;
said elongated rib comprising a tube;
said PC hard strip light set in said tube; and
said PC hard strip light and said elongated rib being connected to each other by single-wall drilling.

8. The apparatus of claim 7, further comprising:
external lamp cap(s) attached to said PC hard strip light by threaded connection.

9. The apparatus of claim 7, further comprising:
a touch electronic circuit including touch induction switch;
said touch electronic circuit capable of turning on and off said PC hard strip light by touches to said pole.

10. The apparatus of claim 7, further comprising:
a winding mechanism; and
a touch electronic circuit including touch induction switch;
said touch electronic circuit capable of turning on and off said PC hard strip light by touches to said winding mechanism.

11. The apparatus of claim 7, further comprising:
a central light at said lower hub; and
a touch electronic circuit including touch induction switch with a circular control section at said central light;
said touch electronic circuit capable of turning on and off said central light by touches to said circular control section.

12. The apparatus of claim 7, further comprising:
a central light at said lower hub; and
a touch electronic circuit including touch induction switch;
said touch electronic circuit having a first control section and a second control section at said central light;
said touch electronic circuit capable of turning on and off said central light by touches to said first control section;
said touch electronic circuit capable of turning on and off said PC hard strip light by touches to said second control section.

13. The apparatus of claim 7, further comprising:
a central light at said lower hub; and
a touch electronic circuit including touch induction switch;
said touch electronic circuit configured to react to touches by cycling between states;
said states being (a) said central light on and said PC hard strip light off, (b) said central light off and said PC hard strip light on, (c) said central light on and said PC hard strip light on, and (d) said central light off and said PC hard strip light off.
